(19) United States
(12) Patent Application Publication
(10) Pub. No.: US 2015/0159087 A1
(43) Pub. Date: Jun. 11, 2015

(54) LIQUID CRYSTAL COMPOSITION HAVING NEGATIVE DIELECTRIC ANISOTROPY, AND LIQUID CRYSTAL DISPLAY DEVICE USING THE LIQUID CRYSTAL COMPOSITION

(71) Applicant: DIC CORPORATION, Tokyo (JP)

(72) Inventors: Haruki Ohishi, Kita-adachi-gun (JP); Shirou Taniguchi, Kita-adachi-gun (JP); Kunihiko Kotani, Kitaadachi-gun (JP); Kazunori Maruyama, Kita-adachi-gun (JP)

(73) Assignee: DIC CORPORATION, Tokyo (JP)

(21) Appl. No.: 14/403,760

(22) PCT Filed: May 22, 2013
(86) PCT No.: PCT/JP2013/064198

§ 371 Date: Nov. 25, 2014

(30) Foreign Application Priority Data
May 28, 2012 (JP) 2012-120783

(51) Int. Cl. C09K 19/32; C09K 19/30

(52) U.S. Cl. CPC C09K 19/322; C09K 19/3098

(57) ABSTRACT

Provided are a liquid crystal composition having negative dielectric anisotropy and a liquid crystal display device that uses the liquid crystal composition. The present invention relates to a liquid crystal composition having a negative dielectric anisotropy (Δ∈) and useful as an electro-optic liquid crystal display material, and a liquid crystal display device that uses the liquid crystal composition. The liquid crystal composition contains one or more compounds represented by general formula (I) and one or more compounds represented by general formula (II). Since the rate of change in operation voltage versus temperature can be decreased by using the liquid crystal composition of the present invention, the invention is effective for improving the display quality in a low-temperature zone. Thus, the liquid crystal composition is suitable for use in vehicle-mounted displays and mobile appliances that are expected to be used in cold areas and outdoors.

### TECHNICAL FIELD

The present invention relates to a liquid crystal composition having negative dielectric anisotropy (Δ∈) and useful as an electro-optic liquid crystal display material, and a liquid crystal display device that uses the liquid crystal composition.

### BACKGROUND ART

Vertical alignment-liquid crystal displays (VA-LCDs) that use liquid crystal compositions having negative dielectric anisotropy (negative Δ∈) are capable of creating pure black and thus have high display quality. VA-LCDs are ubiquitous mainly in the liquid crystal television market as high-contrast liquid crystal display devices. In recent years, VA-LCDs have been increasingly employed in active-matrix driving systems such as liquid crystal televisions and in passive matrix driving systems used in displays to be mounted in vehicles and home electric appliances. Vehicle-mounted displays and the like are required to work in a wide temperature range and maintain high display quality; hence, the temperature dependence of the operation voltage of the liquid crystal composition is preferably as flat as possible.

It is relatively easy to make the temperature dependence of operation voltage flat for a liquid crystal composition having positive Δ∈ and this can be achieved by improving the temperature dependence of operation voltage in a high-temperature zone. The temperature dependence of the operation voltage in the high-temperature zone has been improved by increasing the nematic transition temperature (T_{NI}) of the liquid crystal composition or increasing the specific resistivity of the liquid crystal composition. In contrast, in order to make the temperature dependence of the operation voltage flat for a liquid crystal composition having negative Δ∈, it is necessary to improve the temperature dependence of the operation voltage in a low-temperature zone but no effective means has been found to achieve this.

Although a large number of proposals related to liquid crystal compounds and liquid crystal compositions have been made for liquid crystal materials for VA-LCDs, there have been no reports related to combinations of liquid crystal compounds that can make the temperature dependence of the operation voltage flat.

### CITATION LIST

### Patent Literature

PTL 1: Japanese Unexamined Patent Application Publication No. 2006-241214

PTL 2: Japanese Unexamined Patent Application Publication No. 2006-225450

PTL 3: Japanese Unexamined Patent Application Publication No. 2001-40354

### SUMMARY OF INVENTION

### Technical Problem

An object of the present invention is to provide a liquid crystal composition that has negative dielectric anisotropy and in which the temperature dependence of the operation voltage is flat, and a liquid crystal display device that uses the liquid crystal composition.

### Solution to Problem

The present invention provides a liquid crystal composition that contains one or more compounds represented by general formula (I) and one or more compounds represented by formula (II), and a liquid crystal display device that uses the liquid crystal composition.

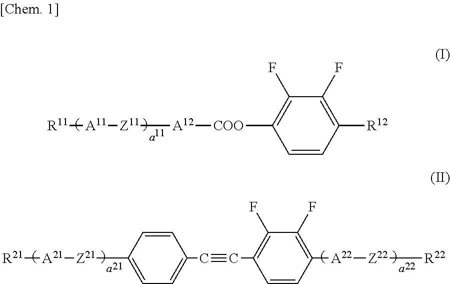

(In the formulae, R¹¹, R¹², R²¹, and R²² each independently represent an alkyl group having 1 to 8 carbon atoms, an alkoxy group having 1 to 8 carbon atoms, or an alkenyl group having 2 to 8 carbon atoms and are each independently unsubstituted or have at least one halogen group as a substituent, and one or more —CH₂— present in these groups may each be independently substituted with —O—, —S—, —CO—, —COO—, —OCO—, or —OCO—O—, provided that oxygen atoms are not directly bonded to each other;
A¹¹, A¹², A²¹, and A²² each independently represent a group selected from the group consisting of
(a) a trans-1,4-cyclohexylene group (where one —CH₂— or two or more non-adjacent —CH₂— present in this group may be substituted with —O— and/or —S—),
(b) a 1,4-phenylene group (where one —CH₂— or two or more non-adjacent —CH₂— groups present in this group may be substituted with —N—), and
(c) 1,4-cyclohexenylene, 1,4-bicyclo(2.2.2)octylene, piperidine-1,4-diyl, naphthalene-2,6-diyl, decahydronaphthalene-2,6-diyl, and 1,2,3,4-tetrahydronaphthalene-2,6-diyl,
where hydrogen atoms in the group (a), group (b), and group (c) may each be independently substituted with an alkyl group having 1 to 3 carbon atoms, an alkenyl group having 2 or 3 carbon atoms, an alkoxyl having 1 to 3 carbon atoms, an alkenyloxy group having 1 to 3 carbon atoms, a CN, or a halogen;
Z¹¹, Z²¹, and Z²² each independently represent —COO—, —OCO—, —CH₂O—, —OCH₂—, —CF₂O—, —OCF₂—, —CH₂CH₂—, —CH═CH—, —C≡C—, —(CH₂)₄—, —CH═CH—CH₂CH₂—, —CH₂CH₂—CH═CH—, or a single bond; and a¹¹, a²¹, and a²² each independently represent 0 or 1.)

According to the liquid crystal composition of the present invention, the rate of change in operation voltage versus temperature ranging from 25° C. to −20° C. is within ±4% with respect to 25° C. This liquid crystal composition is effective for improving display quality in a low-temperature zone. Accordingly, the liquid crystal composition is suitable for use in vehicle-mounted displays and mobile appliances that are expected to be used in cold areas and outdoors.

### DESCRIPTION OF EMBODIMENTS

Individual components will now be described.

### <Compounds Represented by General Formulae (I) and (II)>

A liquid crystal composition contains one or more compounds represented by general formula (I) and one or more compounds represented by general formula (II).

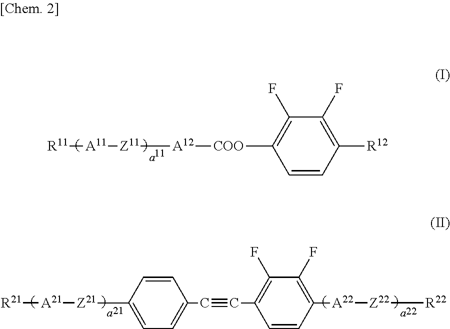

In the formulae, R¹¹, R¹², R²¹, and R²² each independently represent an alkyl group having 1 to 8 carbon atoms, an alkoxy group having 1 to 8 carbon atoms, or an alkenyl group having 2 to 8 carbon atoms and are each independently unsubstituted or have at least one halogen group as a substituent; and one or more —CH₂— present in these groups may each be independently substituted with —O—, —S—, —CO—, —COO—, —OCO—, or —OCO—O—, provided that oxygen atoms are not directly bonded to each other. In the present invention, R¹¹, R¹², R²¹, and R²² preferably each independently represent an alkyl group having 1 to 8 carbon atoms or an alkoxy group having 1 to 8 carbon atoms, and more preferably each independently represent an alkyl group having 1 to 5 carbon atoms or an alkoxy group having 1 to 5 carbon atoms. These groups are preferably unsubstituted.

A¹¹, A¹², A²¹, and A²² each independently represent a group selected from the group consisting of the following:

(a) a trans-1,4-cyclohexylene group (where one —CH₂— or two or more non-adjacent —CH₂— present in this group may be substituted with —O— and/or —S—);
(b) a 1,4-phenylene group (where one —CH₂— or two or more non-adjacent —CH₂— groups present in this group may be substituted with —N—); and
(c) 1,4-cyclohexenylene, 1,4-bicyclo(2.2.2)octylene, piperidine-1,4-diyl, naphthalene-2,6-diyl, decahydronaphthalene-2,6-diyl, and 1,2,3,4-tetrahydronaphthalene-2,6-diyl.
Hydrogen atoms in the group (a), group (b), and group (c) may each be independently substituted with an alkyl group having 1 to 3 carbon atoms, an alkenyl group having 2 or 3 carbon atoms, an alkoxyl having 1 to 3 carbon atoms, an alkenyloxy group having 1 to 3 carbon atoms, a CN, or a halogen. In the present invention, A¹¹, A¹², A²¹, and A²² preferably each independently represent a trans-1,4-cyclohexylene group or a 1,4-phenylene group, more preferably a trans-1,4-cyclohexylene group if low viscosity is desirable, and more preferably a 1,4-phenylene group if a large birefringence anisotropy is desirable. These groups are preferably unsubstituted.

Z¹¹, Z²¹, and Z²² each independently represent —COO—, —OCO—, —CH₂O—, —OCH₂—, —CF₂O—, —OCF₂—, —CH₂CH₂—, —CH═CH—, —C≡C—, —(CH₂)₄—, —CH═CH—CH₂CH₂—, —CH₂CH₂—CH═CH—, or a single bond, but preferably a single bond in the present invention.

While a¹¹, a²¹, and a²² each independently represent 0 or 1, a¹¹, a²¹, and a²² in the present invention preferably each independently represent 0 if low viscosity is desirable and a¹¹ preferably represents 1 and a²¹+a²² is preferably 1 or 2 if high transition temperature is desirable.

### <Compounds Represented by General Formula (III)>

The liquid crystal composition of the present invention can contain one or more compounds represented by general formula (III).

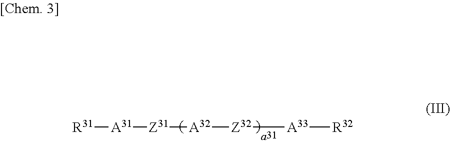

In the formula, R³¹ and R³² each independently represent an alkyl group having 1 to 8 carbon atoms, an alkoxy group having 1 to 8 carbon atoms, or an alkenyl group having 2 to 8 carbon atoms and are each independently unsubstituted or have at least one halogen group as a substituent; and one or more —CH₂— present in these groups may each be independently substituted with —O—, —S—, —CO—, —COO—, —OCO—, or —OCO—O—, provided that oxygen atoms are not directly bonded to each other. In the present invention, R³¹ and R³² preferably each independently represent an alkyl group having 1 to 8 carbon atoms or an alkoxy group having 1 to 8 carbon atoms and more preferably each independently represent an alkyl group having 1 to 5 carbon atoms or an alkoxy group having 1 to 5 carbon atoms. These groups are preferably unsubstituted.

A³¹, A³², and A³³ each independently represent a group selected from the group consisting of the following:

(a) a trans-1,4-cyclohexylene group (where one —CH₂— or two or more non-adjacent —CH₂— present in this group may be substituted with —O— and/or —S—);
(b) a 1,4-phenylene group (where one —CH₂— or two or more non-adjacent —CH₂— groups present in this group may be substituted with —N—); and
(c) 1,4-cyclohexenylene, 1,4-bicyclo(2.2.2)octylene, piperidine-1,4-diyl, naphthalene-2,6-diyl, decahydronaphthalene-2,6-diyl, and 1,2,3,4-tetrahydronaphthalene-2,6-diyl.
Hydrogen atoms in the group (a), group (b), and group (C) may each be independently substituted with an alkyl group having 1 to 3 carbon atoms, an alkenyl group having 2 or 3 carbon atoms, an alkoxyl having 1 to 3 carbon atoms, an alkenyloxy group having 1 to 3 carbon atoms, a CN, or a halogen but at least one of A³¹, A³², and A³³ represents a 2,3-difluoro-1,4-phenylene group. In the present invention, A³¹, A³², and A³³ preferably each independently represent a trans-1,4-cyclohexylene group if low viscosity is desirable, preferably each independently represent a 1,4-phenylene group or naphthalene-2,6-diyl if larger birefringence is desirable, and preferably each independently represent naphthalene-2,6-diyl, decahydronaphthalene-2,6-diyl, or 1,2,3,4-tetrahydronaphthalene-2,6-diyl if large dielectric anisotropy /Δ∈/ is desirable.

Z³¹ and Z³² each independently represent —COO—, —OCO—, —CH₂O—, —OCH₂—, —CF₂O—, —OCF₂—, —CH₂CH₂—, —CH═CH—, —C≡C—, —(CH₂)₄—, —CH═CH—CH₂CH₂—, —CH₂CH₂—CH═CH—, or a single bond. In the present invention, Z³¹ and Z³² preferably each independently represent —CH₂O—, —OCH₂—, or a single bond.

### <Compounds Represented by General Formula (IV)>

The liquid crystal composition of the present invention can contain one or more compounds represented by general formula (IV).

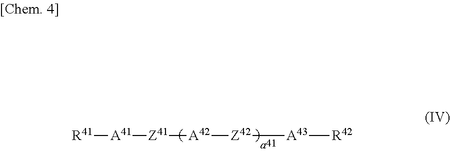

In the formula, R⁴¹ and R⁴² each independently represent an alkyl group having 1 to 8 carbon atoms, an alkoxy group having 1 to 8 carbon atoms, or an alkenyl group having 2 to 8 carbon atoms and are each independently unsubstituted or have at least one halogen group as a substituent; and one or more —CH₂— present in these groups may each be independently substituted with —O—, —S—, —CO—, —COO—, —OCO—, or —OCO—O—, provided that oxygen atoms are not directly bonded to each other. In the present invention, R⁴¹ and R⁴² preferably each independently represent an alkyl group having 1 to 8 carbon atoms or an alkoxy group having 1 to 8 carbon atoms, and more preferably each independently represent an alkyl group having 1 to 5 carbon atoms or an alkoxy group having 1 to 5 carbon atoms. These groups are preferably unsubstituted.

A⁴¹, A⁴², and A⁴³ each independently represent a group selected from the group consisting of the following:

(a) a trans-1,4-cyclohexylene group (where one —CH₂— or two or more non-adjacent —CH₂— present in this group may be substituted with —O— and/or —S—);
(b) a 1,4-phenylene group (where one —CH₂— or two or more non-adjacent —CH₂— groups present in this group may be substituted with —N—); and
(c) 1,4-cyclohexenylene, 1,4-bicyclo(2.2.2)octylene, piperidine-1,4-diyl, naphthalene-2,6-diyl, decahydronaphthalene-2,6-diyl, and 1,2,3,4-tetrahydronaphthalene-2,6-diyl.
Hydrogen atoms in the group (a), group (b), and group (c) may each be independently substituted with an alkyl group having 1 to 3 carbon atoms, an alkenyl group having 2 or 3 carbon atoms, an alkoxyl having 1 to 3 carbon atoms, an alkenyloxy group having 1 to 3 carbon atoms, a CN, or a halogen. In the present invention, A⁴¹, A⁴², and A⁴³ preferably each independently represent a trans-1,4-cyclohexylene group if low viscosity is desirable and preferably each independently represent a 1,4-phenylene group or naphthalene-2,6-diyl if large birefringence is desirable.

A⁴¹, A⁴², and A⁴³ never represent a 2,3-dihalo-1,4-phenylene group; and

Z⁴¹ and Z⁴² each independently represent —COO—, —OCO—, —CH₂O—, —OCH₂—, —CF₂O—, —OCF₂—, —CH₂CH₂—, —CH═CH—, —C≡C—, —(CH₂)₄—, —CH═CH—CH₂CH₂—, —CH₂CH₂—CH═CH—, or a single bond. In the present invention, Z⁴¹ and Z⁴² preferably each independently represent a single bond if low viscosity is desirable and preferably each independently represent —C≡C— if large birefringence is desirable.

While a⁴¹ represents 0, 1, or 2, two A⁴² that are present when a⁴¹ represents 2 may be the same or different from each other and two Z³² that are present when a⁴¹ represents 2 may be the same or different from each other. In the present invention, a⁴¹ preferably represents 0 if low viscosity is desirable and preferably represents 1 or 2 if high transition temperature is desirable.

### <Compounds Represented by General Formulae (V) and (VI)>

The liquid crystal composition of the present invention may further contain compounds represented by formulae V and VI.

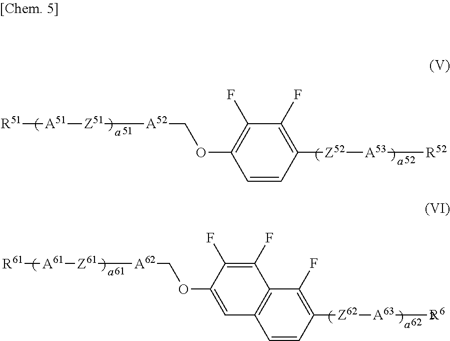

In the formulae, R⁵¹ and R⁶¹ each independently denote the same as R³¹ in general formula (III) and R⁵² and R⁶² each independently denote the same as R³² in general formula (III).

A⁵¹, A⁵², A⁵³, A⁶¹, A⁶², and A⁶³ each independently represent a trans-1,4-cyclohexylene group, a 1,4-phenylene group, or 1,4-cyclohexenylene, where one or more hydrogen atoms in the 1,4-phenylene group may each be independently substituted with a halogen. In the present invention, A⁵¹, A⁵², A⁵³, A⁶¹, A⁶², and A⁶³ preferably each independently represent a trans-1,4-cyclohexylene group or a 1,4-phenylene group, preferably a trans-1,4-cyclohexylene group if low viscosity is desirable, and preferably a 1,4-phenylene group if large birefringence is desirable.

Z⁵¹, Z⁵², Z⁶¹, and Z⁶² each independently represent —COO—, —OCO—, —CH₂O—, —OCH₂—, —CF₂O—, —OCF₂—, —CH₂CH₂—, —CH═CH—, —C≡C—, —(CH₂)₄—, —CH═CH—CH₂CH₂—, —CH₂CH₂—CH═CH—, or a single bond. In the present invention, Z⁵¹, Z⁵², Z⁶¹, and Z⁶² preferably each independently represent —CH₂O—, —OCH₂—, or a single bond.

While a⁵¹, a⁵², a⁶¹, and a⁶² each independently represent 0, 1, or 2, a⁵¹+a⁵² is 0, 1, or 2 and a⁶¹+a⁶² is 0, 1, or 2. Two A⁵¹ that are present when a⁵¹ represents 2 may be the same or different, two A⁵² that are present when a⁵² represents 2 may be the same or different, two Z⁵¹ that are present when a⁵¹ represents 2 may be the same or different, two Z⁵² that are present when a⁵² represents 2 may be the same or different, two A⁶¹ that are present when a⁶¹ represents 2 may be the same or different, two A⁶² that are present when a⁶² represents 2 may be the same or different, two Z⁶¹ that are present when a⁶¹ represents 2 may be the same or different, and two Z⁶² that are present when a⁶² represents 2 may be the same or different. In the present invention, a⁵¹, a⁵², a⁶¹, and a⁶² each preferably represent 0 if low viscosity is desirable and a⁵¹+a⁵² and a⁶¹+a⁶² are each preferably 1 or 2 if high transition temperature is desirable.

### <Compounds Represented by General Formula (VII)>

The liquid crystal composition according to the present invention may contain, as a compound represented by general formula (VII), one or more compounds represented by general formula (VII).

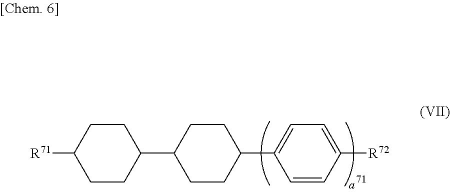

In the formula, R⁷¹ denotes the same as R⁴¹ in general formula (IV), R⁷² denotes the same as R⁴² in general formula (IV), and a⁷¹ represents 0 or 1. When low viscosity is desirable, a⁷¹ preferably represents 0 and when high transition temperature is desirable, a⁷¹ preferably represents 1.

The liquid crystal composition according to the present invention may contain nematic liquid crystals, smectic liquid crystals, cholesteric liquid crystals, an antioxidant, a UV absorber, a polymerizable monomer, etc., that are common in the art in addition to the compounds described above as long as the advantages of the invention of the present application are not impaired. However, the liquid crystal composition according to the present invention preferably does not contain a liquid crystal compound that has a partial structure in which heteroatoms are directly bonded to each other, such as —O—O—, —O—S—, and —S—S—.

The polymerizable monomer that may be contained in the liquid crystal composition of the present invention is preferably a photopolymerizable monomer. In the case where the polymerizable monomer is contained, the photopolymerizable monomer content of the liquid crystal composition according to the present invention is preferably 500 to 5000 ppm. Examples of the photopolymerizable monomer include monomers having polymerizable unsaturated double bonds such as acrylate esters and methacrylate esters.

In the case where the liquid crystal composition according to the present invention is used in an active matrix driving liquid crystal display device, Tₙᵢ of the liquid crystal composition according to the present invention is preferably 60 to 120° C. The lower limit is more preferably 65° C. and particularly preferably 70° C. The upper limit is more preferably 110° C. and particularly preferably 105° C. Δ∈ at 25° C. is preferably −1.5 to −6.0, more preferably −2.0 to −5.0, and particularly preferably −2.0 to −3.5. Δn at 25° C. is preferably 0.08 to 0.13 and more preferably 0.09 to 0.12. To be more specific, Δn at 25° C. is preferably 0.10 to 0.12 to be compatible with a small cell gap and is preferably 0.08 to 0.10 to be compatible with a large cell gap. The viscosity (η) at 20° C. is preferably 10 to 30 mPa·s, more preferably 10 to 25 mPa·s, and most preferably 10 to 20 mPa·s.

In the case where the liquid crystal composition according to the present invention is used in a passive matrix driving liquid crystal display device, Tₙᵢ of the liquid crystal composition according to the present invention is preferably 60 to 120° C. for consumer use. The lower limit is more preferably 65° C. and most preferably 70° C. The upper limit is more preferably 90° C. and most preferably 80° C. For vehicle-mounting usage, the lower limit is more preferably 90° C. and most preferably 100° C. The upper limit is more preferably 115° C. and most preferably 105° C. For low-duty driving, Δn at 25° C. is preferably 0.08 to 0.13 and more preferably 0.08 to 0.11. For high duty driving, Δn at 25° C. is preferably 0.13 to 0.20 and more preferably 0.15 to 0.18. For low duty driving, Δ∈ at 25° C. is preferably −2.0 to −7.0 and more preferably −2.5 to −5.5. Moreover, η at 20° C. is preferably 10 to 40 mPa·s, more preferably 10 to 30 mPa·s, and most preferably 10 to 25 mPa·s.

Tₙᵢ, Δ∈, and Δn of the liquid crystal composition according to the present invention can be appropriately adjusted within the ranges suitable for the usage of the liquid crystal composition by adjusting the contents of various compounds including the first component and the second component. For the liquid crystal composition of the present invention, Tₙᵢ is preferably 70° C. to 120° C., Δ∈ at 25° C. and 1 KHz is preferably −1.5 to −8.0, and Δn at 25° C. and 589 nm is preferably 0.080 to 0.250. When Tₙᵢ, Δ∈, and Δn are within these ranges, the liquid crystal composition can be appropriately used in various usages.

A liquid crystal display device having a vertical aligning property can be produced by using the liquid crystal composition of the present invention. For example, a liquid crystal display device with a 80° to 90° pretilt angle can be produced by using the liquid crystal composition of the present invention.

### EXAMPLES

The present invention will now be described in further detail by using Examples which do not limit the scope of the present invention. For the compositions of Examples and Comparative Examples below, “%” means “% by mass”.

The terminologies used in Examples are as follows:

Tₙᵢ: nematic-isotropic transition temperature [° C.]
T_{→N}: solid or smectic-nematic transition temperature [° C.]
Δn: refractive index anisotropy (589 nm, 25° C.)
n₀: refractive index for ordinary rays (589 nm, 25° C.)
Δ∈: dielectric anisotropy (1 kHz, 25° C.)
∈_{⊥}: dielectric constant in a direction perpendicular to a molecular axis (1 kHz, 25° C.)
η: bulk flow viscosity [mPa·s] (20° C.)
Response speed: The liquid crystal composition was poured into a vertical alignment cell having a 3.5 μm gap and 89° pretilt angle and response speed was measured at 5 V with 100 Hz square waves.
Voltage-temperature characteristic (temperature dependence of operation voltage): A value obtained by dividing Vth (threshold voltage (V)) at −20° C. by Vth at 25° C. was evaluated.

The following abbreviations are used in describing the compounds of Examples:

Abbreviations for side chains are as follows:

-n (numeral): —CₙH₂ₙ₊₁ (an alkyl side chain is denoted by a numeral and represented by R)

### -On: —OCₙH₂ₙ₊₁

-ndm: —(CₙH₂ₙ₊₁—C═C—(CH₂)ₘ₋₁)
ndm-: CₙH₂ₙ₊₁—C═C—(CH₂)ₘ₋₁—
-nOm: —(CH₂)ₙOCₘH₂ₘ₊₁
nOm-: CₙH₂ₙ₊₁O(CH₂)ₘ—
-Od(m)n: —O(CₙH₂ₙ₊₁—C═C—(CH₂)ₘ₋₂)
d(m)nO-: CₙH₂ₙ₊₁—C═C—(CH₂)ₘ₋₂O—

Abbreviations for bonding groups are as follows:

### -T-: —C≡C—

### -2-: —CH₂CH₂—

### -1O—: —CH₂—O—

### —O1-: —O—CH₂—

### —VO—: —COO—

Abbreviations for rings are as follows:

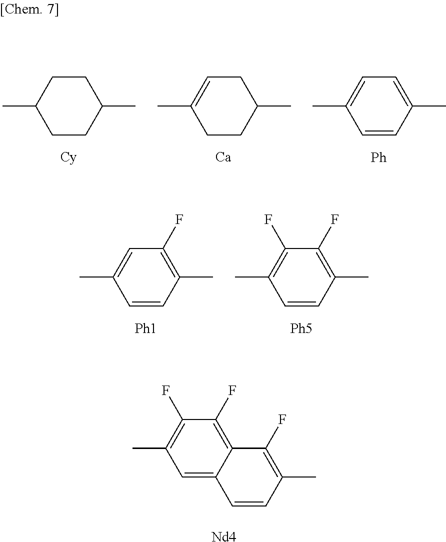

Liquid crystal compositions described in Table 1 are produced and compared in terms of temperature dependence of operation voltage.

TABLE 1

| | | Compar- | | |
|---|---|---|---|---|
| | | ative | Example | Example |
| | | Example 1 | 1 | 2 |
| T_{NI} | | 101.7 | 102.1 | 100.9 |
| T_{→N} | | G-60 | G-59 | G-53 |
| Δn | | 0.102 | 0.104 | 0.105 |
| nₒ | | 1.484 | 1.479 | 1.482 |
| Δε | | −3.29 | −3.22 | −3.16 |
| ε_{⊥} | | 6.66 | 6.72 | 6.44 |
| η | | 22.0 | 21.1 | 30.3 |
| Voltage-temperature | | 0.93 | 0.97 | 1.00 |
| characteristics | | | | |
| Vth@−20° C./Vth@25° C. | | | | |
| (I) | 3-Cy-VO—Ph5—O2 | | 8 | 5 |
| (I) | 4-Cy-VO—Ph5—O2 | | 8 | 5 |
| (I) | 5-Cy-VO—Ph5—O2 | | 8 | 5 |
| (I) | 3-Cy-Cy-VO—Ph5—O2 | | 8 | 5 |
| (II) | 3-Ph-T-Ph5—O2 | | | 3 |
| (II) | 5-Ph-T-Ph5—O2 | | | 3 |
| (II) | 3-Cy-Ph-T-Ph5—O2 | 5 | 5 | |
| (II) | 5-Cy-Ph-T-Ph5—O2 | 5 | 5 | |
| (III) | 3-Cy-Cy-Ph5—O2 | | | 7 |
| (III) | 3-Cy-Cy-Ph5—O3 | | | 7 |
| (III) | 5-Cy-Cy-Ph5—O2 | | | 7 |
| (III) | 2-Cy-Ph—Ph5—O2 | | | 6 |
| (III) | 3-Cy-Ph—Ph5—O2 | | | 7 |
| (III) | 3-Cy-1O—Nd4—O4 | 4 | 3 | |
| (III) | 5-Cy-1O—Nd4—O2 | 4 | 3 | |
| (III) | 5-Cy-1O—Nd4—O3 | 4 | 3 | |
| (III) | 0d1-Cy-1O—Ph5—O1-Cy-2 | 8 | | |
| (III) | 0d1-Cy-1O—Ph5—O1-Cy-3 | 8 | | |
| (III) | 0d1-Cy-1O—Ph5—O1-Cy-5 | 8 | | |
| (IV) | 0d1-Cy-Cy-5 | 13 | 8 | |
| (IV) | 0d1-Cy-Cy-3 | 20 | 20 | |
| (IV) | 3-Ca-Cy-5 | | | 25 |
| (IV) | 3-Cy-Ph—O2 | | | |
| (IV) | 0d1-Cy-Cy-Ph-1 | 12 | 5 | 5 |
| (IV) | 0d3-Cy-Cy-Ph-1 | 9 | 10 | 10 |
| (IV) | 3-Ph—VO-Cy-VO—Ph-3 | | 3 | |
| (IV) | 4-Ph—VO-Cy-VO—Ph-4 | | 3 | |

In Comparative Example 1, the operation voltage (Vth) at −20° C. versus 25° C. was 93° C. In contrast, in Examples 1 and 2, the operation voltage at −20° C. versus 25° C. was 97 to 100%. Improvements of temperature dependence were thus observed.

### INDUSTRIAL APPLICABILITY

A liquid crystal composition according to the present invention is useful for use in liquid crystal display devices, namely, active matrix driving liquid crystal display devices and passive matrix driving liquid crystal display devices, and is particularly useful for use in passive matrix driving liquid crystal display devices. The liquid crystal composition can also be used in VA-mode, PSVA-mode, IPS-mode, or ECB-mode liquid crystal display devices.

1. A liquid crystal composition comprising one or more compounds represented by general formula (I) and one or more compounds represented by general formula (II): 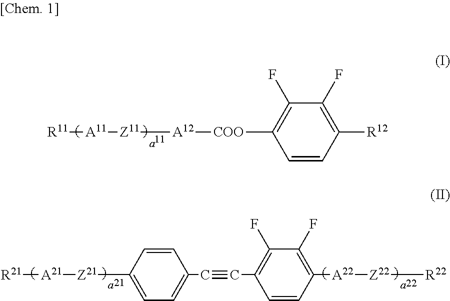
(In the formulae, R¹¹, R¹², R²¹, and R²² each independently represent an alkyl group having 1 to 8 carbon atoms, an alkoxy group having 1 to 8 carbon atoms, or an alkenyl group having 2 to 8 carbon atoms and are each independently unsubstituted or have at least one halogen group as a substituent, and one or more —CH₂— present in these groups may each be independently substituted with —O—, —S—, —CO—, —COO—, —OCO—, or —OCO—O—, provided that oxygen atoms are not directly bonded to each other;
A¹¹, A¹², A²¹, and A²² each independently represent a group selected from the group consisting of
(a) a trans-1,4-cyclohexylene group (where one —CH₂— or two or more non-adjacent —CH₂— present in this group may be substituted with —O— and/or —S—),
(b) a 1,4-phenylene group (where one —CH₂— or two or more non-adjacent —CH₂— groups present in this group may be substituted with —N—), and
(c) 1,4-cyclohexenylene, 1,4-bicyclo(2.2.2)octylene, piperidine-1,4-diyl, naphthalene-2,6-diyl, decahydronaphthalene-2,6-diyl, and 1,2,3,4-tetrahydronaphthalene-2,6-diyl,
where hydrogen atoms in the group (a), group (b), and group (c) may each be independently substituted with an alkyl group having 1 to 3 carbon atoms, an alkenyl group having 2 or 3 carbon atoms, an alkoxyl having 1 to 3 carbon atoms, an alkenyloxy group having 1 to 3 carbon atoms, a CN, or a halogen;
Z¹¹, Z²¹, and Z²² each independently represent —COO—, —OCO—, —CH₂O—, —OCH₂—, —CF₂O—, —OCF₂—, —CH₂CH₂—, —CH═CH—, —C≡C—, —(CH₂)₄—, —CH═CH—CH₂CH₂—, —CH₂CH₂—CH═CH—, or a single bond; and
a¹¹, a²¹, and a²² each independently represent 0 or 1.)

2. The liquid crystal composition according to claim 1, comprising one or more compounds represented by general formula (III): 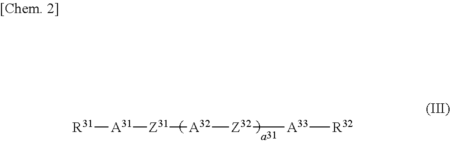
(In the formula, R³¹ and R³² each independently represent an alkyl group having 1 to 8 carbon atoms, an alkoxy group having 1 to 8 carbon atoms, or an alkenyl group having 2 to 8 carbon atoms and are each independently unsubstituted or have at least one halogen group as a substituent, and one or more —CH₂— present in these groups may each be independently substituted with —O—, —S—, —CO—, —COO—, —OCO—, or —OCO—O—, provided that oxygen atoms are not directly bonded to each other;
A³¹, A³², and A³³ each independently represent a group selected from the group consisting of
(a) a trans-1,4-cyclohexylene group (where one —CH₂— or two or more non-adjacent —CH₂— present in this group may be substituted with —O— and/or —S—),
(b) a 1,4-phenylene group (where one —CH₂— or two or more non-adjacent —CH₂— groups present in this group may be substituted with —N—), and
(c) 1,4-cyclohexenylene, 1,4-bicyclo(2.2.2)octylene, piperidine-1,4-diyl, naphthalene-2,6-diyl, decahydronaphthalene-2,6-diyl, and 1,2,3,4-tetrahydronaphthalene-2,6-diyl,
where hydrogen atoms in the group (a), group (b), and group (c) may each be independently substituted with an alkyl group having 1 to 3 carbon atoms, an alkenyl group having 2 or 3 carbon atoms, an alkoxyl having 1 to 3 carbon atoms, an alkenyloxy group having 1 to 3 carbon atoms, a CN, or a halogen but at least one of A³¹, A³², and A³³ represents a 2,3-difluoro-1,4-phenylene group, a 1,7,8-trifluoronaphthalene-2,6-diyl group, or a 3,4,5-trifluoronaphthalene-2,6-diyl group;
Z³¹ and Z³² each independently represent —COO—, —OCO—, —CH₂O—, —OCH₂—, —CF₂O—, —OCF₂—, —CH₂CH₂—, —CH═CH—, —C≡C—, —(CH₂)₄—, —CH═CH—CH₂CH₂—, —CH₂CH₂—CH═CH—, or a single bond; and
a³¹ represents 0, 1, or 2, two A³² that are present when a³¹ represents 2 may be the same or different, two Z³² that are present when a³¹ represents 2 may be the same or different, and general formula (III) never represents the compounds represented by general formula (I) or the compounds represented by general formula (II).)

3. The liquid crystal composition according to claim 1, comprising one or more compounds represented by general formula (IV): 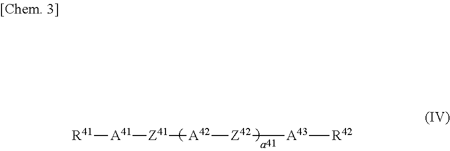
(In the formula, R⁴¹ and R⁴² each independently represent an alkyl group having 1 to 8 carbon atoms, an alkoxy group having 1 to 8 carbon atoms, or an alkenyl group having 2 to 8 carbon atoms and are each independently unsubstituted or have at least one halogen group as a substituent, and one or more —CH₂— present in these groups may each be independently substituted with —O—, —S—, —CO—, —COO—, —OCO—, or —OCO—O—, provided that oxygen atoms are not directly bonded to each other;
A⁴¹, A⁴², and A⁴³ each independently represent a group selected from the group consisting of
(a) a trans-1,4-cyclohexylene group (where one —CH₂— or two or more non-adjacent —CH₂— present in this group may be substituted with —O— and/or —S—);
(b) a 1,4-phenylene group (where one —CH₂— or two or more non-adjacent —CH₂— groups present in this group may be substituted with —N—); and
(c) 1,4-cyclohexenylene, 1,4-bicyclo(2.2.2)octylene, piperidine-1,4-diyl, naphthalene-2,6-diyl, decahydronaphthalene-2,6-diyl, and 1,2,3,4-tetrahydronaphthalene-2,6-diyl,
where hydrogen atoms in the group (a), group (b), and group (c) may each be independently substituted with an alkyl group having 1 to 3 carbon atoms, an alkenyl group having 2 or 3 carbon atoms, an alkoxyl having 1 to 3 carbon atoms, an alkenyloxy group having 1 to 3 carbon atoms, a CN, or a halogen but A⁴¹, A⁴², and A⁴³ never represent a 2,3-dihalo-1,4-phenylene group;
Z⁴¹ and Z⁴² each independently represent —COO—, —OCO—, —CH₂O—, —OCH₂—, —CF₂O—, —OCF₂—, —CH₂CH₂—, —CH═CH—, —C≡C—, —(CH₂)₄—, —CH═CH—CH₂CH₂—, —CH₂CH₂—CH═CH—, or a single bond; and
A⁴¹ represents 0, 1, or 2, two A⁴² that are present when a⁴¹ represents 2 may be the same or different and two Z³² that are present when a⁴¹ represents 2 may be the same or different.)

4. The liquid crystal composition according to claim 2, wherein one or more compounds selected from the group consisting of compounds represented by general formula (V) and general formula (VI) are contained as the one or more compounds represented by general formula (III): 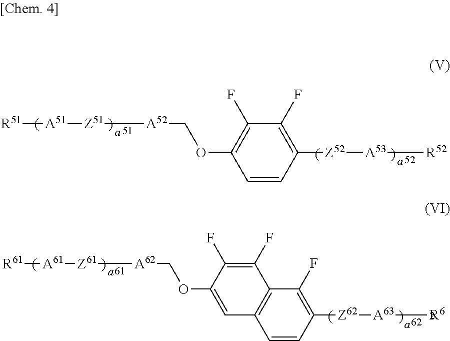
(In the formulae, R⁵¹ and R⁶¹ each independently denote the same as R³¹ in claim 2 and R⁵² and R⁶² each independently denote the same as R³² in claim 2,
A⁵¹, A⁵², A⁵³, A⁶¹, A⁶², and A⁶³ each independently represent a trans-1,4-cyclohexylene group, a 1,4-phenylene group, or 1,4-cyclohexenylene, where one or more hydrogen atoms in the 1,4-phenylene group may each be independently substituted with a halogen;
Z⁵¹, Z⁵², Z⁶¹, and Z⁶² each independently represent —COO—, —OCO—, —CH₂O—, —OCH₂—, —CF₂O—, —OCF₂—, —CH₂CH₂—, —CH═CH—, —C≡C—, —(CH₂)₄—, —CH═CH—CH₂CH₂—, —CH₂CH₂—CH═CH—, or a single bond; and
a⁵¹, a⁵², a⁶¹, and a⁶² each independently represent 0, 1, or 2, a⁵¹+a⁵² is 0, 1, or 2, and a⁶¹+a⁶² is 0, 1, or 2, where two A⁵¹ that are present when a⁵¹ represents 2 may be the same or different, two A⁵² that are present when a⁵² represents 2 may be the same or different, two Z⁵¹ that are present when a⁵¹ represents 2 may be the same or different, two Z⁵² that are present when a⁵² represents 2 may be the same or different, two A⁶¹ that are present when a⁶¹ represents 2 may be the same or different, two A⁶² that are present when a⁶² represents 2 may be the same or different, two Z⁶¹ that are present when a⁶¹ represents 2 may be the same or different, and two Z⁶² that are present when a⁶² represents 2 may be the same or different.)

5. The liquid crystal composition according to claim 3, wherein one or more compounds represented by general formula (VII) are contained as the one or more compounds represented by general formula (IV): 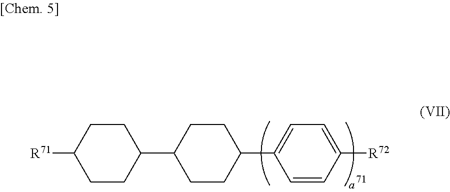
(In the formula, R⁷¹ denotes the same as R⁴¹ in claim 3, R⁷² denotes the same as R⁴² in claim 3, and a⁷¹ represents 0 or 1.)

6. The liquid crystal composition according to claim 2, wherein a total amount of the compounds represented by general formula (I), the compounds represented by general formula (II), and the compounds represented by general formula (III) is in the range of 50% by mass to 100% by mass of the entire liquid crystal composition.

7. The liquid crystal composition according to claim 1, having a nematic-isotropic transition temperature of 70° C. to 120° C., a dielectric anisotropy of −1.5 to −8.0, and a birefringence of 0.080 to 0.250.

8. The liquid crystal composition according to claim 1, comprising 500 to 5000 ppm of a monomer.

9. A liquid crystal display device that uses the liquid crystal composition according to claim 1.

10. The liquid crystal display device according to claim 9, having a pretilt angle of 80° to 90°.

11. The liquid crystal display device according to claim 9, wherein the liquid crystal display device is of an active matrix driving type.

12. The liquid crystal display device according to claim 9, wherein the liquid crystal display device is of a passive matrix driving type.
